(19) United States
(12) Patent Application Publication
(10) Pub. No.: US 2018/0137595 A1
(43) Pub. Date: May 17, 2018

(54) DISPLAY DEVICE AND OPERATION METHOD THEREFOR

(71) Applicant: LG INNOTEK CO., LTD., Seoul (KR)

(72) Inventors: Soon Beom KIM, Seoul (KR); Dong Woon KIM, Gwacheon-si (KR); Ju Hyeon PARK, Seoul (KR); Su Woo LEE, Seoul (KR); Sung Min HONG, Seoul (KR)

(73) Assignee: LG INNOTEK CO., LTD., Seoul (KR)

(21) Appl. No.: 15/575,252

(22) PCT Filed: May 9, 2016
(86) PCT No.: PCT/KR2016/004779

§ 371 Date: Nov. 17, 2017

(30) Foreign Application Priority Data
May 19, 2015 (KR) 10-2015-0070017

(51) Int. Cl. G06Q 50/30; B60K 35/00; B60R 1/00; B60Q 9/00; B60N 5/00; H04N 7/18; G06K 9/00; G06Q 30/02; G06Q 50/14

(52) U.S. Cl. CPC G06Q 50/30; B60K 35/00; B60R 1/00; B60Q 9/00; B60N 5/00; G01S 19/51; G06K 9/00791; G06Q 30/0284; G06Q 50/14; B60K 2350/2013; B60K 2350/352; H04N 7/183

(57) ABSTRACT

According to an embodiment, a display device mounted inside a vehicle includes a first communication unit configured to be connected to a camera and receive an image of an outside of the vehicle captured by the camera; a location information acquiring unit configured to acquire location information of the vehicle; a control unit configured to determine a destination of the vehicle and control a display time point of the image received through the first communication unit on the basis of the destination of the vehicle and the acquired location information; and a display unit configured to display the image captured by the camera according to a control signal of the control unit.

### TECHNICAL FIELD

Embodiments relate to a display device, and more particularly, to a display device mounted on a vehicle, and an operating method thereof.

### BACKGROUND ART

As a vehicle travels on a road, a driver or a passenger needs to frequently get into and out of the vehicle. When a driver or a passenger gets into and out of a vehicle on a road, a vehicle or a motorcycle approaches particularly from the rear of the vehicle, and when the driver or the passenger gets into and out of the vehicle without paying attention to such a situation, there is a problem that the person getting out of is at risk.

In order to solve the problem, conventionally, when a door of the vehicle with a red light attached to an inner lower part of the door is opened, a method of recognizing the red light by a vehicle approaching from the rear may be used. Alternatively, a method of warning a rear vehicle that a door of a front vehicle is opened is used. However, when a driver of a rear vehicle does not recognize a situation in which a door of a front vehicle is opened, those methods are useless, and there is a problem in that safety of passengers at a time of getting into and out of a vehicle is not sufficiently secured.

### DISCLOSURE

### Technical Problem

An embodiment provides a display device capable of intuitively detecting a dangerous situation for a user and displaying an image acquired through a camera arranged outside a vehicle when a passenger or a driver gets out of the vehicle, and an operating method thereof.

In addition, an embodiment provides a display device capable of transmitting boarding information of a passenger on a business vehicle to a family member or a friend of the passenger for safety of the passenger, and an operating method thereof.

Further, an embodiment provides a display device capable of providing various pieces of information to a passenger or a driver in the vehicle when the vehicle travels, and an operating method thereof.

Technical problems to be solved by the embodiments proposed herein are not limited to those mentioned above, and other unmentioned technical aspects should be clearly understood by one of ordinary skill in the art to which the embodiments proposed herein pertain from the description below.

### Technical Solution

According to an embodiment, a display device mounted inside a vehicle includes a first communication unit configured to be connected to a camera and receive an image of an outside of the vehicle captured by the camera; a location information acquiring unit configured to acquire location information of the vehicle; a control unit configured to determine a destination of the vehicle and control a display time point of the image received through the first communication unit on the basis of the destination of the vehicle and the acquired location information; and a display unit configured to display the image captured by the camera according to a control signal of the control unit.

Furthermore, the display time point may include a time point at which the vehicle approaches within a predetermined distance radius of the destination.

In addition, the display time point may be a getting-out time point of a passenger aboard the vehicle based on the destination.

Further, the display time point may include a time point at which a fare payment event occurs.

Furthermore, the control unit may control the display unit to display travel-related information of the vehicle together with the captured image at the display time point, and the travel-related information may include at least one of travel distance information, traveling route information, and fare information.

In addition, the control unit may analyze the captured image, determine whether a predetermined object exists in the captured image, and control the display device to output a warning signal according to whether an object exists in the captured image.

Further, the control unit may output a door lock signal for locking a door of the vehicle when the predetermined object exists in the captured image.

Furthermore, the control unit may control the display unit to display vehicle-related information when a passenger aboard the vehicle is detected, and the vehicle-related information may include vehicle information including at least one of a vehicle number and a vehicle type, and driver information including at least one of a driver name, a license registration number, and an affiliated company.

In addition, the display device may further include a second communication unit configured to perform communication with a first terminal of a passenger when the passenger is detected aboard the vehicle, wherein the second communication unit may receive destination information of the passenger transmitted from the first terminal, and the control unit may set the destination of the vehicle using the destination information received through the second communication unit.

Further, the control unit may transmit boarding information of a passenger to an outside when the destination is set, and the boarding information may include at least one of a boarding time, boarding vehicle information, driver information, departure information, destination information, and information on a required time to the destination.

Furthermore, the control unit may transmit the boarding information to at least one of the first terminal and a second terminal of another person registered in the first terminal, and the second communication unit may acquire information of the second terminal through communication with the first terminal.

Further, the control unit may control the display device to transmit additional boarding information to any one of the first and second terminals according to a predetermined notification condition, and the additional boarding information may further include real-time current location information according to movement of the vehicle.

Furthermore, the display device may further include a third communication unit configured to acquire fare payment information from a fare payment device in accordance with an occurrence of the fare payment event.

In addition, the control unit may control a predetermined piece of content to be displayed through the display unit while the vehicle travels, and the piece of content may include at least one of an advertisement, news, a map around the destination, and traffic situation information on a route of the vehicle.

According to another embodiment, an operating method of a display device includes acquiring traveling information of a vehicle; acquiring current location information of the vehicle; determining a getting-out time point of a passenger on the basis of the acquired travel information and current location information; and displaying a captured image of an outside of the vehicle at the getting off time point.

Furthermore, the determining of a getting-out time point may include determining whether the vehicle enters a nearby area within a radius of a predetermined distance from the destination on the basis of the current location and determining a time point at which the vehicle enters the nearby area as the getting-out time point.

In addition, the operating method of a display device may further include determining whether a fare payment event occurs, wherein the captured outside image is displayed when the fare payment event occurs.

Further, the operating method of a display device may further include outputting a warning signal according to whether a predetermined object exists in the captured outside image.

Furthermore, the operating method of a display device may further include communicating with a first terminal of the passenger and receiving destination information of the passenger when the passenger is detected aboard the vehicle.

In addition, the operating method of a display device may further include transmitting boarding information of the vehicle to at least any one of the first terminal and a second terminal acquired from the first terminal at a predetermined information transmission time.

### Advantageous Effects

According to an embodiment of the present invention, when a passenger boards a vehicle, information on the vehicle boarded by the passenger and information of a driver are displayed, and when a destination for a traveling place of the vehicle is set, the boarding information is transmitted to an acquaintance of the passenger, and thus the safety of the passenger can be ensured.

In addition, according to an embodiment of the present invention, various additional pieces of information such as commercial broadcasting, information on surroundings of a destination, news information, real-time traffic situation information, route information, and real-time fare information are provided while a vehicle is traveling, thereby eliminating boredom of a passenger while the vehicle is traveling to the destination and improving user satisfaction.

Further, according to an embodiment of the present invention, when a passenger gets out of a vehicle, an image of surroundings of the vehicle acquired through a camera is displayed, and when a traveling object such as a motorcycle exists in the surroundings of the vehicle, a warning signal is output or a vehicle door is locked such that the vehicle door cannot be opened, thereby safely protecting the passenger at a time at which the passenger gets out of the vehicle.

### DESCRIPTION OF DRAWINGS

FIG. 1 is a view schematically illustrating a configuration of an information providing system according to an embodiment of the present invention.

FIG. 2 is a block diagram of a display system according to an embodiment of the present invention.

FIG. 3 is a block diagram illustrating a detailed configuration of a display device 110 shown in FIG. 2.

FIG. 4 is a flowchart sequentially describing an operating method of a display device according to an embodiment of the present invention.

FIG. 5 is a flowchart sequentially illustrating an operating method of a display device in a boarding mode according to an embodiment of the present invention.

FIG. 6 illustrates vehicle information and driver information provided according to an embodiment of the present invention.

FIG. 7 is a flowchart sequentially illustrating a method of setting a destination of a terminal according to an embodiment of the present invention.

FIG. 8 illustrates a destination setting screen displayed by the terminal according to an embodiment of the present invention.

FIGS. 9 and 10 are flowcharts for sequentially describing a method for transmitting boarding information of the display device (110) according to an embodiment of the present invention.

FIG. 11 is a flowchart sequentially illustrating an operating method of a display device in a traveling mode according to an embodiment of the present invention.

FIGS. 12 to 14 are flowcharts for sequentially describing a method for selecting content according to an embodiment of the present invention.

FIG. 15 is a flowchart sequentially illustrating a method of controlling a display screen in the traveling mode according to an embodiment of the present invention.

FIGS. 16 and 17 illustrate information displayed through a display unit 1171.

FIG. 18 is a flowchart sequentially illustrating an operating method of a display device in a getting-out mode according to an embodiment of the present invention.

FIG. 19 illustrates a display screen in the getting-out mode according to an embodiment of the present invention.

FIGS. 20 and 21 are flowcharts for sequentially describing an operating method of a display device according to another embodiment of the present invention.

### MODES OF THE INVENTION

Advantages, features, and methods for achieving the advantages and features will become clear with reference to embodiments which will described below in detail with reference to the accompanying drawings. However, the present disclosure is not limited to the embodiments disclosed below and may be implemented in various other forms. The embodiments are merely provided to make the disclosure of the present disclosure complete and completely inform those skilled in the art to which the present disclosure pertains of the scope of the present disclosure. The present disclosure is only defined by the scope of the claims. Like reference numerals refer to like elements throughout the specification.

In descriptions of embodiments of the present disclosure, when a detailed description of a known function or configuration is deemed to unnecessarily obscure the gist of the present disclosure, the detailed description will be omitted. Terms described below are terms defined in consideration of functions in the embodiments of the present disclosure and may vary depending on an intention of a user or operator or a practice. Therefore, such terms should be defined on the basis of all of the content disclosed herein.

Combinations of blocks and steps of flowcharts in the accompanying drawings can be implemented as computer program instructions. Such computer program instructions can be embedded in a processor of a general-purpose computer, a special-purpose computer, or other programmable data processing equipment. Therefore, the instructions executed by the processor of the other programmable data processing equipment generate means for performing a function described in each of the blocks or each of the steps in the flowcharts in the drawings. Because the computer program instructions can also be saved in a computer-usable or computer-readable memory capable of allowing a computer or other programmable data processing equipment to implement a function in a specific way, the instructions stored in the computer-usable or computer-readable memory can also produce a manufactured item which incorporates an instruction means performing a function described in each of the blocks or each of the steps of the flowcharts in the drawings. Because the computer program instructions can also be embedded in a computer or other programmable data processing equipment, instructions executed in the computer or the other programmable data processing equipment by executing a process generated as a series of operational steps in the computer or the other programmable data processing equipment can also provide steps for executing functions described in each of the blocks and each of the steps of the flowcharts in the drawings.

In addition, each of the blocks or each of the steps may represent a module, a segment, or a part of a code including one or more executable instructions for executing a specified logical function(s). Also, it should be noted that functions mentioned in the blocks or steps can also be performed in a different order in a few alternative embodiments. For example, two blocks or steps which are consecutively illustrated can be performed at substantially the same time, or the blocks or steps can also sometimes be performed in a reverse order according to corresponding functions.

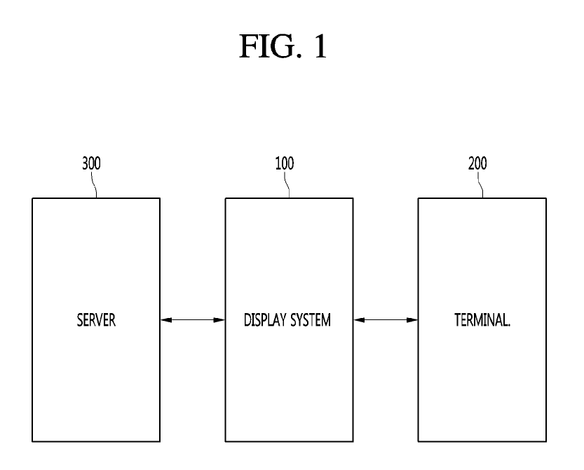

FIG. 1 is a view schematically illustrating a configuration of an information providing system according to an embodiment of the present invention.

Referring to FIG. 1, an information providing system includes a display system 100, a terminal 200, and a server 300.

The display system 100 is mounted on a vehicle and provides information on the vehicle and various additional pieces of information for convenience of passengers in the vehicle.

The display system 100 may include a display device 110 installed inside the vehicle and a camera 120 installed outside the vehicle to acquire a surrounding image outside the vehicle.

The terminal 200 is a personal device owned by a passenger inside the vehicle and communicates with the display system 100 to exchange information related to traveling of the vehicle and various pieces of information for safety or convenience of the passenger.

The terminal 200 may include a mobile phone, a smartphone, a laptop computer, a digital broadcasting terminal, a personal digital assistant (PDA), a portable multimedia player (PMP), and a navigation device.

The server 300 communicates with the display system 100 and transmits various pieces of information required by the display system 100 to the display system 100.

The server 300 may store various pieces of content such as advertisements or news to be displayed on the display device 110 of the display system 100 while the vehicle equipped with the display system 100 travels, and accordingly, the server 300 may transmit the stored content to the display system 100.

In addition, the server 300 may perform some operations performed by the display device 110 constituting the display system 100.

In other words, an operation performed by a control unit 118 while the display device 110 is operated, which will be described below, may be performed by the server 300.

Accordingly, the display device 110 may perform only a general display function, and an operation of controlling the display function of the display device 110 may be performed by the server 300.

That is, the display device 110 includes a communication unit 111. Accordingly, it is possible to transmit a received signal (for example, a destination setting signal, a fare payment signal, a camera image, and the like) from the outside to the server 300.

In addition, the server 300 may generate a control signal for controlling operation of the display device 110 on the basis of a received signal transmitted from the display device 110.

Further, the display device 110 may receive the control signal generated by the server 300 through the communication unit 111 and perform an operation accordingly.

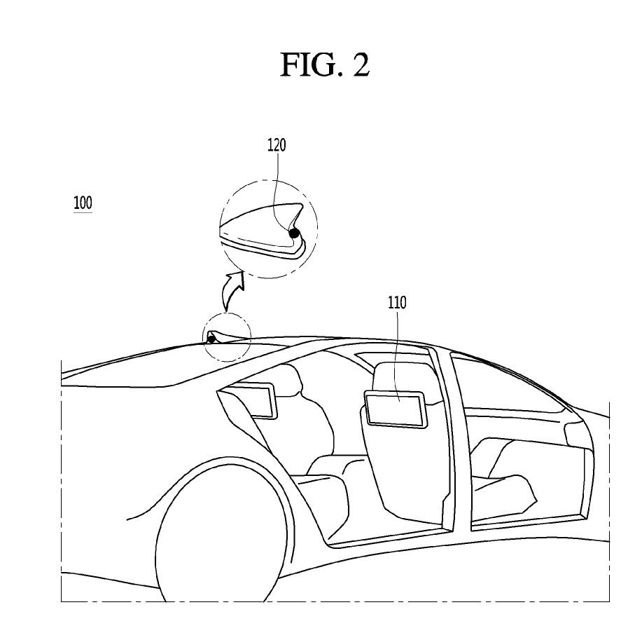

FIG. 2 is a block diagram of a display system according to an embodiment of the present invention.

Referring to FIG. 2, the display system 100 may include the display device 110 and the camera 120.

The display device 110 is installed inside the vehicle and displays various additional pieces of information to be provided to passengers aboard the vehicle.

At this point, although the display device 110 is installed in a rear seat of a vehicle in the drawings, this is only an example and an installation location of the display device 110 may be changed according to a user.

In other words, when the user is a driver or a passenger in a passenger seat, the display device 110 may be installed in a center fascia of a front seat of the vehicle.

The camera 120 is installed outside the vehicle to capture the surrounding image of the outside of the vehicle, and transmits the captured surrounding image to the display device 110.

At this point, the camera 120 is preferably a rear camera for capturing an image behind the vehicle.

However, the present invention is not limited thereto, and an installation location of the camera 120 may be changed according to an embodiment, and the number of mounted cameras may be increased.

For example, the camera 120 may include a first camera mounted on a door handle of a vehicle, a second camera mounted on a taxi cap when the vehicle is a taxi, a third camera mounted on a shark antenna, as shown in FIG. 2, and a fourth camera installed on a trunk or a license plate of the vehicle.

In some cases, the camera 120 may further include a fifth camera installed inside the vehicle to acquire an image of the inside the vehicle in addition to the surrounding image of the vehicle.

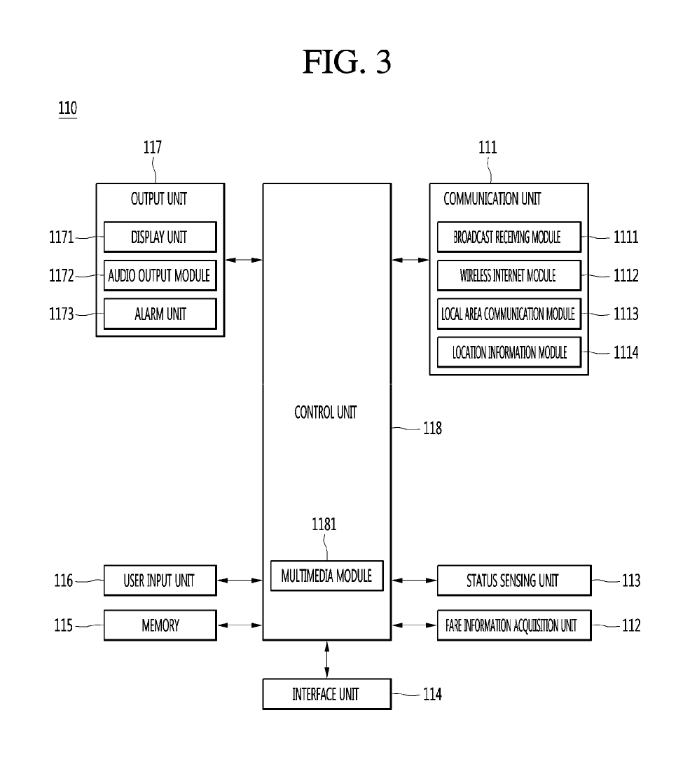

FIG. 3 is a block diagram illustrating a detailed configuration of the display device 110 shown in FIG. 2.

Referring to FIG. 3, the display device 110 includes the communication unit 111, a fare information acquisition unit 112, a status sensing unit 113, an interface unit 114, a memory 115, a user input unit 116, and an output unit 117.

The communication unit 111 may include one or more modules that enable wireless communication between the display device 110 and the wireless communication system (more specifically, the camera 120, the terminal 200, and the server 300).

For example, the communication unit 111 may include a broadcast receiving module 1111, a wireless Internet module 1112, a local area communication module 1113, a location information module 1114, and the like.

The broadcast receiving module 1111 receives broadcast signals and/or broadcast-related information from an external broadcast management server through a broadcast channel.

The broadcast channel may include a satellite channel and a terrestrial channel. The broadcast management server may be a server which generates and transmitting broadcast signals and/or broadcast-related information, or a server which receives generated broadcast signals and/or broadcast-related information and transmits the received broadcast signals and/or broadcast related-information to a terminal. The broadcast signal may include a TV broadcast signal, a radio broadcast signal, a data broadcast signal, and also a broadcast signal in which a data broadcast signal is combined with a TV broadcast signal or a radio broadcast signal.

The broadcast-related information may be a broadcast channel, a broadcast program, or information related to a broadcast service provider.

The broadcast related information may exist in various forms. For example, the broadcast related information may exist as an Electronic Program Guide (EPG) of Digital Multimedia Broadcasting (DMB), an Electronic Service Guide (ESG) of Digital Video Broadcast-Handheld (DVB-H), or the like.

For example, the broadcast receiving module 1111 may receive a digital broadcast signal using a digital broadcast system such as a Digital Multimedia Broadcasting-Terrestrial (DMB-T) system, a Digital Multimedia Broadcasting-Satellite (DMB-S) system, a Media Forward Link Only (MediaFLO) system, a DVB-H system, and an Integrated Services Digital Broadcast-Terrestrial (ISDB-T) system. In addition, the broadcast receiving module 1111 may be configured to be applied to other broadcasting systems in addition to the digital broadcasting system described above.

The broadcast signals and/or broadcast-related information received through the broadcast receiving module 1111 may be stored in the memory 115.

The wireless Internet module 1112 may be a module for wireless Internet access and may be built into or externally mounted on the display device 110. Wireless local area network (WLAN), Wi-Fi, Wireless broadband (Wibro), World Interoperability for Microwave Access (Wimax), High Speed Downlink Packet Access (HSDPA), or the like may be used as wireless Internet technology therefor.

The local area communication module 1113 refers to a module for local area communication. Bluetooth, radio frequency identification (RFID), infrared data association (IrDA), ultra wideband (UWB), ZigBee, Near Field Communication (NFC) communication, or the like may be used as a short distance communication technology therefor.

The location information module 1114 is a module for acquiring a location of the display device 110, and a representative example thereof is a Global Position System (GPS) module.

The wireless Internet module 1112 may be wirelessly connected to the camera 120 and may receive an image obtained through the camera 120.

Alternatively, the image acquired through the camera 120 may be input thereto through a separate image input unit (not shown). In other words, the image obtained through the camera 120 may be received as a wireless signal through the wireless Internet module 1112 or may be input by a wired line through the separate image input unit.

The camera 120 processes an image frame such as a still image or a moving image obtained by an image sensor in a capturing mode. The processed image frame may be displayed on a display unit 1171.

The image frame processed by the camera 120 may be stored in the memory 115 or transmitted to the outside through the communication unit 111. At least two or more cameras 120 may be provided according to a usage environment.

The user input unit 116 generates input data for controlling an operation of the display device 110 by a user. The user input unit 116 may include a key pad dome switch, a touch pad (static pressure/electro static), a jog wheel, a jog switch, and the like.

The output unit 117 generates an output related to a visual, auditory, or tactile sense. The output unit 117 may include the display unit 1171, a sound output module 1172, an alarm unit 1173, and the like.

The display unit 1171 displays information processed in the display device 110. For example, when a vehicle enters a boarding mode, the display unit 1171 displays information of the vehicle and information of a driver driving the vehicle.

In addition, when the vehicle enters a traveling mode, the display unit 1171 displays various pieces of content (advertisement, news, a map, or the like) transmitted from the server 300.

Further, when the vehicle enters a getting-out mode, the display unit 1171 displays the image captured by the camera 120.

The display unit 1171 may include at least one of a liquid crystal display (LCD), a thin film transistor-liquid crystal display (TFT LCD), an organic light-emitting diode (OLED), a flexible display, and a three-dimensional display (3D display).

Some of these displays may be configured to be transparent or light transmissive types of displays such that the outside is visible therethrough. The display may be referred to as a transparent display, and a typical example of the transparent display is a transparent OLED (TOLED) or the like. A rear structure of the display unit 1171 may also be configured to be light transmissive. With this structure, an object located behind a display device body may be visible to the user through an area occupied by the display unit 1171 of the display device body.

There may be two or more display units 1171 according to an embodiment of the display device 110. For example, a plurality of display units may be spaced apart or disposed integrally on one surface of the display device 170 or may be disposed on different surfaces thereof.

When the display unit 1171 and a sensor for sensing a touch operation (hereinafter, referred to as a “touch sensor”) are configured in a stacked structure (Hereinafter, referred to as a “touch screen”), the display unit 1171 may be used as an input device in addition to an output device. The touch sensor may have the form of, for example, a touch film, a touch sheet, a touch pad, or the like.

The touch sensor may be configured to convert a change in pressure applied to a specific portion of the display unit 1171 or a change in capacitance generated on the specific portion of the display unit 1171 into an electrical input signal. The touch sensor may be configured to detect pressure in addition to a location and area to be touched a time of a touch.

When a touch is input to the touch sensor, a corresponding signal(s) is transmitted to a touch controller. The touch controller processes the signal(s) and transmits corresponding data to the control unit 118. Thus, the control unit 118 may know which area of the display unit 1171 is touched or the like.

Meanwhile, a proximity sensor (not shown) may be disposed in a vicinity of the touch screen or in an inner area of the display device 110 to be surrounded by the touch screen. The proximity sensor (not shown) refers to a sensor that detects the presence or absence of an object approaching a predetermined detection surface or an object existing in proximity to the detection surface using an electromagnetic force or infrared ray without mechanical contact. The proximity sensor (not shown) has a longer lifetime and higher utilization than a contact sensor.

Examples of the proximity sensor (not shown) include a transmissive type photoelectric sensor, a direct reflection type photoelectric sensor, a mirror reflection type photoelectric sensor, a high frequency oscillation type proximity sensor, a capacitive proximity sensor, a magnetic proximity sensor, and an infrared ray proximity sensor. When the touch screen is electrostatic, the touch screen is configured to detect proximity of a pointer as a change of an electric field according to the proximity of the pointer. In this case, the touch screen (touch sensor) may be classified as the proximity sensor.

At this point, the proximity sensor (not shown) may be the status sensing unit 113, which will be described later.

The status sensing unit 113 detects a status of a user located around the display device 110, that is, a passenger in the vehicle.

Accordingly, the status sensing unit 113 may be implemented as the proximity sensor to detect whether a passenger is present or absent and whether the passenger approaches the surroundings of the display device 110.

The status sensing unit 113 may be implemented as a camera (not shown) located inside the vehicle.

That is, the status sensing unit 113 may acquire a surrounding image of the display device 110. When the surrounding image is acquired by the status sensing unit 113, the control unit 118 may analyze the obtained surrounding image and determine whether an object corresponding to a passenger is present or absent in the image, and thus the presence or absence of a passenger in the vehicle may be detected.

In addition, when an object exists in addition to the passenger being present, the control unit 118 may detect an eye region of the passenger on the object to determine whether the passenger is in a sleep state according to the detected state of the eye region.

The audio output module 1172 may output audio data received from the communication unit 111 or stored in the memory 115. The audio output module 1172 also outputs a sound signal related to a function performed in the display device 110. The audio output module 1172 may include a receiver, a speaker, a buzzer, and the like.

The alarm unit 1173 outputs a signal for notifying the passenger of the occurrence of an event of the display device 110 or a signal for notifying the passenger of a warning situation.

The video signal or the audio signal may be output through the display unit 1171 or the audio output module 1172, and thus the display unit 1171 or the audio output module 1172 may be classified as a part of the alarm unit 1173.

The memory 115 may store a program for an operation of the control unit 118 and temporarily store input/output data (for example, still images, moving images, or the like).

The memory 115 may include at least one type of storage medium among a flash memory type storage medium, a hard disk type storage medium, a multimedia card micro type storage medium, a card type memory (for example, a secure digital (SD) or extreme digital (XD) memory or the like), a random access memory (RAM), a static random access memory (SRAM), a read-only memory (ROM), an electrically erasable programmable read-only memory (EEPROM), a programmable read-only memory (PROM), a magnetic memory, a magnetic disc, and an optical disc.

In addition, the memory 115 may store various pieces of content such as advertisements and news to be displayed through the display unit 1171.

The interface unit 114 serves as a path for communication with all external devices connected to the display device 110. The interface unit 114 receives data from an external device, supplies power supplied from the external device transmit the data or the power to each component in the display device 110, or allows data in the display device 110 to be transmitted to the external device. For example, the interface unit 114 may include a wired/wireless headset port, an external charger port, a wired/wireless data port, a memory card port, an audio input/output (I/O) port, a video I/O port, an earphone port, or the like.

The fare information acquisition unit 112 may communicate with a fare charge meter (not shown) existing in a vehicle in which the display device 110 is installed to receive information acquired from the fare charge meter.

The acquired information may include used fare information and travel distance information according to traveling of the vehicle in which the display device 110 is installed.

The control unit 118 typically controls overall operation of the display device 110.

The control unit 118 may include a multimedia module 1181 for multimedia playback. The multimedia module 1181 may be implemented in the control unit 118 or may be implemented separately from the control unit 118.

When a passenger is boards the vehicle, the control unit 118 enters the boarding mode and controls the overall operation of the display device 110.

In addition, when a destination corresponding to a travel location is set after the passenger boards the vehicle, the control unit 118 enters the traveling mode and controls the overall operation of the display device 110.

Further, when the vehicle on which the display device 110 is mounted approaches the destination of the boarded passenger, the control unit 118 enters the getting-out mode and controls the overall operation of the display device 110.

The boarding mode, the traveling mode, and the getting-out mode will be described in more detail below.

Meanwhile, the display device 110 may include a power supply unit (not shown). The power supply unit may receive power from an external power source and an internal power source controlled by the control unit 118 to supply power required for operation of each component.

The various embodiments described herein may be implemented in a recording medium readable by a computer or similar device using, for example, software, hardware, or a combination thereof.

According to a hardware implementation, the embodiments described herein may be implemented using at least one of an application specific integrated circuit (ASIC), a digital signal processor (DSP), a digital signal processing device (DSPD), a programmable logic device (PLD), a field programmable gate array (FPGA), a processor, a controller, a micro-controller, a microprocessor, and an electrical unit for performing another function. In some cases, the embodiments may be implemented by the control unit 118.

In accordance with a software implementation, embodiments such as procedures or functions may be implemented with separate software modules which perform at least one function or operation. The software code may be implemented by a software application written in a suitable programming language. The software codes are stored in the memory 115 and may be executed by the control unit 118.

The following description assumes that the vehicle in which the display device 110 is installed is a taxi, and the display device 110 is used by a passenger in the vehicle.

However, the assumption is only an example, and the vehicle in which the display device 110 is installed may be a vehicle owned by a general person other than a taxi, or may alternatively be a bus.

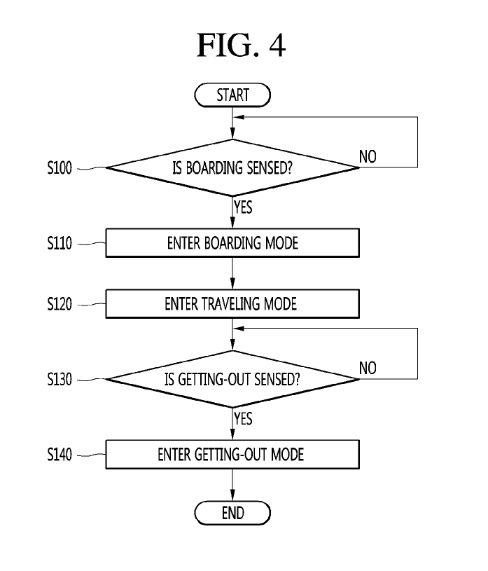

FIG. 4 is a flowchart sequentially for describing an operating method of a display device according to an embodiment of the present invention.

Referring to FIG. 4, the control unit 118 detects whether a passenger is boarding the vehicle in step S100.

That is, the status sensing unit 113 transmits a signal detected from surroundings of the display device to the control unit 118, and the control unit 118 determines whether a passenger is boarding the vehicle on the basis of the transmitted signal.

Here, the signal transmitted from the status sensing unit 113 to the control unit 118 may be a signal indicating whether an access object acquired through the proximity sensor is present. Alternatively, the signal may be a captured image of the surroundings of the display device 110.

At this point, when the status sensing unit 113 transmits the captured image to the control unit 118, the control unit 118 analyzes the captured image, determines whether there is an object corresponding to a passenger boarding in the captured image, and thus detects whether a passenger is boarding or not, according to the presence or absence of an object.

Then, as a result of the determination in step S100, when a passenger boarding the vehicle is detected, the control unit 118 enters the boarding mode in step S110.

Here, the biggest difference for each of a plurality of modes is an image displayed on the display unit 1171.

That is, when a boarding passenger exists and the control unit 118 enters the boarding mode, the control unit 118 displays boarded vehicle information and driver information of the vehicle being boarded to the boarding passenger on the display unit 1171.

In addition, the control unit 118 acquires destination information of the boarding passenger, and sets a destination of the vehicle based on the destination information.

When the destination is set, the control unit 118 transmits the boarding information of the passenger to a terminal owned by the passenger or a terminal registered in advance by the passenger for the safety of the passenger.

At this point, the control unit 118 transmits the boarding information of the passenger at a time at which a notification event corresponding to a notification condition occurs on the basis of a predetermined notification condition.

Here, the boarding information may include information on the vehicle, driver information, departure information, the destination information, information on a time required to travel to the destination according to a surrounding traffic situation, and real-time current location information according to the vehicle traveling.

The boarding information may include time information of a time at which the passenger boarded the vehicle.

Then, when the destination is set and then traveling of the vehicle starts, the control unit 118 enters the traveling mode and displays information corresponding to the traveling mode through the display unit 1171 in step S120.

Here, the information corresponding to the traveling mode may include content for providing additional information such as advertisement, news, and a map, and current time information, traveling distance information of the vehicle, fare information, and traffic situation information on a traveling route to the destination.

Then, the control unit 118 determines whether getting-out of the boarded passenger is detected in step S130.

Here, the detection of the getting-out may be performed in a case in which the presence of a boarded passenger is not detected through the status sensing unit 113, a case in which a present location of the vehicle corresponds to the destination, and a case in which a fare payment event occurs.

In addition, when it is detected that the passenger gets out of the vehicle, the control unit 118 enters the getting-out mode and performs an operation corresponding to the getting-out mode in step S140.

Here, the entering of the getting-out mode preferentially displays an image captured by the camera 120 via the display unit 1171. Accordingly, the passenger that is getting out of the vehicle may check whether an object (a human body, a traveling object, or the like) exists around the vehicle through the displayed image.

Hereinafter, each of the boarding mode, the traveling mode, and the getting-out mode will be described in more detail.

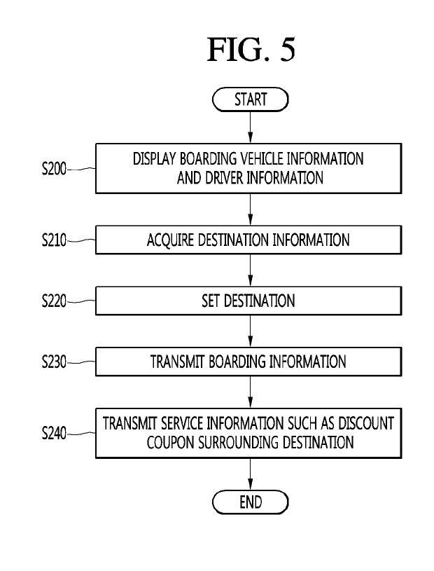

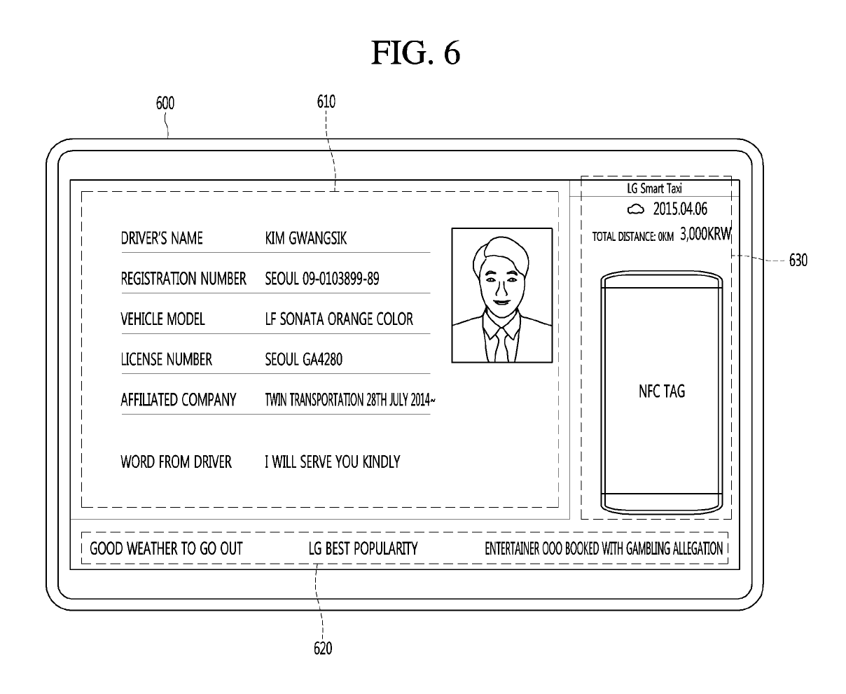

FIG. 5 is a flowchart sequentially illustrating an operating step method of a display device in the boarding mode according to an embodiment of the present invention, and FIG. 6 illustrates vehicle information and driver information provided according to an embodiment of the present invention.

Referring to FIG. 5, when a boarding passenger is detected, the control unit 118 displays information of a vehicle boarded by the passenger and a driver of the vehicle through the display unit 1171 in step S200.

Here, the memory 115 may store information of a vehicle on which the display device 110 is installed and driver information of the vehicle. Accordingly, the control unit 118 extracts the stored vehicle information and driver information from the memory 115 at a time at which the boarding passenger is detected, and thus the extracted vehicle information and driver information may be displayed through the display unit 1171.

Alternatively, the vehicle information and the driver information may be displayed on the display unit 1171 even when a passenger is not boarding the vehicle. Accordingly, when a passenger is boarding the vehicle, the passenger may check the vehicle information and driver information displayed through the display unit 1171.

FIG. 6 illustrates information displayed on a display screen 600 of the display unit 1171.

Referring to FIG. 6, the display screen 600 includes a first area 610, a second area 620, and a third area 630.

Main information is displayed in the first area 610, sub information is displayed in the second area 620, and additional information related to traveling of a vehicle is displayed in the third area 630.

At this point, the vehicle information and the driver information are displayed through the first area 610 of the display screen 600

Information displayed in the first area 610 may include a driver name, a vehicle registration number, a vehicle type, a vehicle number, and affiliated company information.

The sub information is displayed in the second area 620. The sub information may be set according to types of information displayed for the boarding passenger. Alternatively, the sub information may be preset by a driver.

For example, the second area 620 may receive real-time news from the server 300 such that information on the received news can be displayed accordingly.

At this point, news information may be displayed in a ticker form in the second area 620.

In the third area 630, additional information related to the traveling of the vehicle is displayed.

The additional information may include weather information and date information, and may include travel distance information and fare information related to the traveling.

In addition, the additional information may further include different information according to whether the vehicle is in a pre-traveling state, a traveling state, or a traveling completed state.

Here, before the vehicle travels, in order to set a destination for a place the passenger desires to go in the additional information, information for inducing short distance communication with a terminal owned by the passenger may be displayed.

In addition, while the vehicle travels, information corresponding to a traveling route of the vehicle and current traffic situation information on the traveling route may be displayed.

When the traveling of the vehicle is completed (when the vehicle arrives at the destination of the passenger), information for inducing a used fare payment according to the traveling of the vehicle may be displayed.

Referring back to FIG. 5, when the boarded vehicle information and the destination information are displayed, the control unit 118 acquires destination information of the passenger who boards the vehicle in step S210.

Here, the destination information may be acquired from the terminal 200 owned by the boarded passenger, which will be described in detail below.

When the destination information is acquired, the control unit 118 sets a destination of the vehicle using the acquired destination information in step S220.

Here, the destination setting may refer to a destination setting of a navigation system. Accordingly, the display device 110 may include a navigation function.

In addition, the control unit 118 acquires boarding information according to the boarding of the passenger and transmits the boarding information to the outside in step S230.

Here, the boarding information may include information on the vehicle, driver information, departure information, destination information, information on a time required to travel to a destination according to a surrounding traffic situation, and real-time current location information according to the vehicle traveling.

A reception target receiving the boarding information may be the terminal 200 of the passenger used for setting the destination. In addition, alternatively, the control unit 118 may acquire terminal information about an acquaintance of the passenger through the terminal 200 and may transmit the boarding information to an acquaintance terminal corresponding to the acquired terminal information.

Then, the control unit 118 receives service information such as a discount coupon around the destination to which the passenger intends to go from the server 300 and transmits the received service information to the passenger's terminal 200.

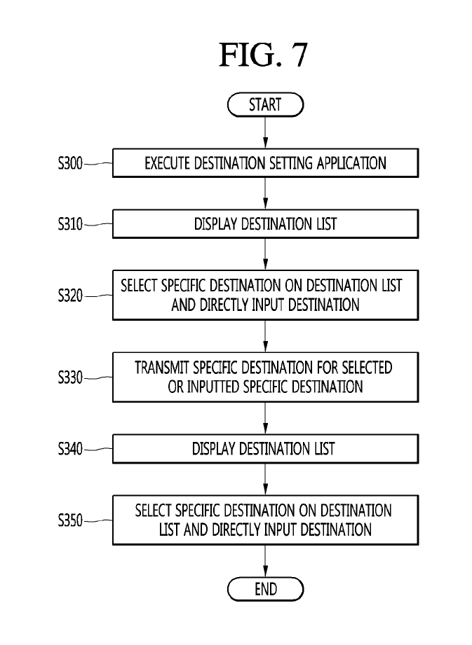

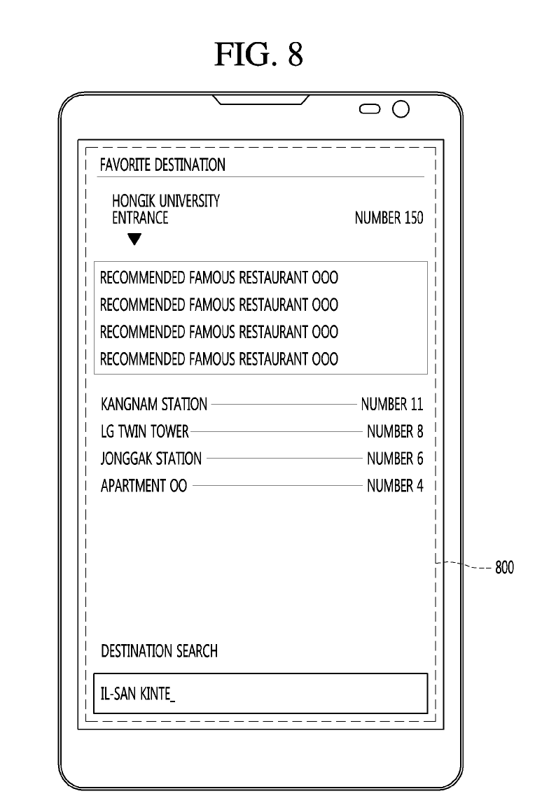

FIG. 7 is a flowchart sequentially illustrating a method of setting a destination of a terminal according to an embodiment of the present invention, and FIG. 8 illustrates a destination setting screen displayed by the terminal according to an embodiment of the present invention.

Referring to FIG. 7, a passenger on a vehicle executes an application for setting a destination on a terminal owned by the passenger in step S300. Here, the application may be an application provided by a smart taxi company corresponding to the vehicle.

When the application is executed, a destination list including destination information for a place frequently visited by a user (the passenger) is displayed on the terminal 200 in step S310.

Referring to FIG. 8, a display screen 800 of the terminal 200 displays destination information for frequently used places according to the application being executed.

The destination information includes a place which the user has actually been, and may include a place recommended by the application.

Further, the display screen 800 includes a destination search window for searching for one of a plurality of destinations.

Furthermore, alternatively, the display screen 800 may further include a destination input window (not shown) for searching for or inputting a new destination other than the displayed destination.

Referring back to FIG. 7, when the destination list is displayed on the display screen 800, the terminal 200 may select one specific destination of the displayed destination list, or may directly receive a new destination not included in the destination list in step S320. In other words, the terminal 200 acquires information on a destination to which the user desires to go.

Then, when the destination information is acquired, the terminal 200 transmits the acquired destination information to the display device 110 in step S330.

At this point, transmission of the destination information may be performed through short distance communication according to the terminal 200 being tagged on the display device 110.

Then, the terminal 200 receives information of the vehicle that the user boarded from the display device 110 in step S340. Here, the vehicle information may be the above-described boarding information.

When the boarding information is received, the terminal 200 transmits the received boarding information to another pre-registered terminal in step S350. Here, the transmission of the boarding information may be performed by the executed application.

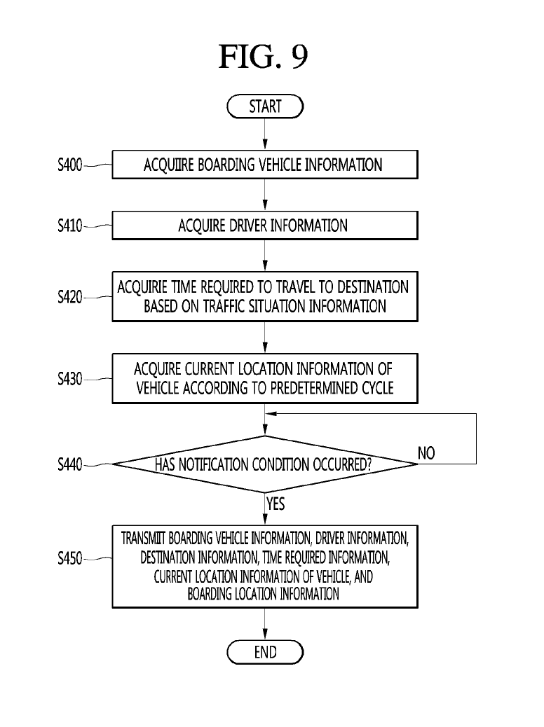

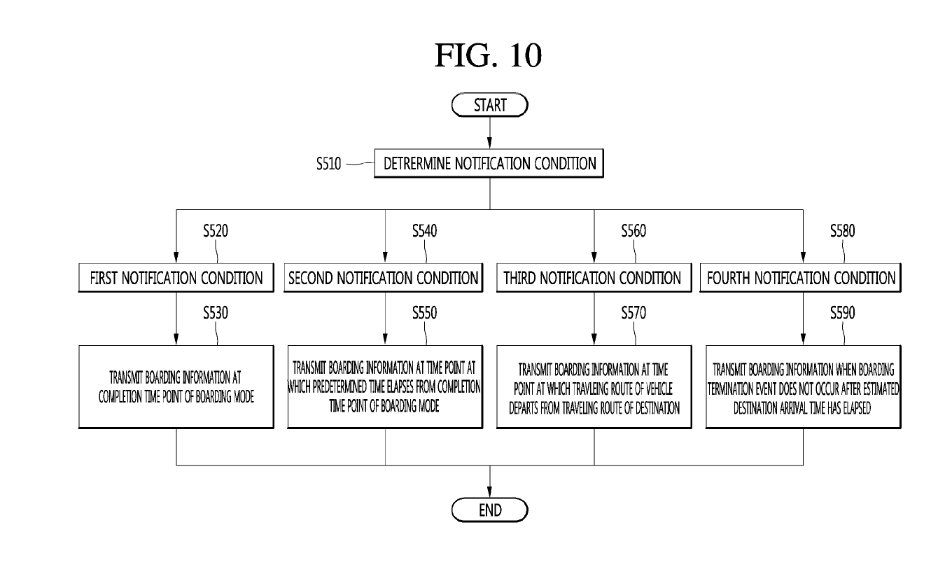

FIGS. 9 and 10 are flowcharts for sequentially describing a method for transmitting boarding information of the display device 110 according to an embodiment of the present invention.

Referring to FIG. 9, the control unit 118 of the display device 110 acquires information about a vehicle on which the display device 110 is installed in step S400. Here, boarded vehicle information may include a vehicle type, a vehicle registration date, a vehicle affiliated company, a vehicle number, and the like. The boarded vehicle information may be stored in the memory 115, and thus the control unit 118 may extract vehicle information stored in the memory 115.

Further, the control unit 118 acquires information on a driver driving the vehicle in step S410. The driver information may include a driver name, a license registration number, and the like. In addition, the driver information may be stored in the memory 115, and thus the control unit 118 may extract the driver information stored in the memory 115.

Then, the control unit 118 acquires set destination information to acquire a travel time from a current location to a destination based on current traffic situation information in step S420.

In addition, the control unit 118 acquires current location information corresponding to the vehicle traveling according to a predetermined period in step S430.

Then, the control unit 118 determines whether a notification condition occurs in step S440. That is, the control unit 118 determines whether a transmission event for transmitting boarding information including the acquired information to an external terminal occurs. The transmission event may be triggered by any one predetermined notification condition among a plurality of notification conditions.

Further, when the notification condition occurs, in other words, when the transmission event occurs, the control unit 118 transmits the boarding information including boarded vehicle information, driver information, departure information (boarding location information), destination information, information on a time required to travel to a destination, and real time current location information of a vehicle to an external terminal in step S440.

Here, the external terminal may be a terminal owned by the passenger. In addition, the control unit 118 may acquire other terminal information (terminal information of an acquaintance) pre-registered in the terminal owned by the passenger, and thus the control unit 118 may transmit the boarding information to an acquaintance terminal corresponding to the acquired terminal information.

Further, the control unit 118 generates the boarding information including the boarded vehicle information, the driver information, the departure information (boarding location information), the destination information, the information of the required time to the destination, and the real time current location information of the vehicle, and may transmit the boarding information to the external terminal at a time of first transmitting the boarding information.

Furthermore, the control unit 118 may transmit only newly changed information to the external terminal except information overlapping the previously transmitted information from the initial transmission time. The newly changed information includes information of the required time to the destination and the real-time current location information.

Referring to FIG. 10, the control unit 118 determines a notification condition for transmitting the boarding information in step S510.

In addition, when the determined notification condition is a first notification condition in step S520, the control unit 118 transmits the boarding information to the external terminal when the boarding mode is completed in step S530. Here, a completion time of the boarding mode may be a time point at which the destination of the vehicle is set.

Further, when the boarding information is transmitted to the external terminal according to the first notification condition, the control unit 118 acquires only the changed boarding information at a predetermined time interval and continuously transmits the boarding information to the external terminal.

Furthermore, when the determined notification condition is a second notification condition in step S540, the control unit 118 transmits the boarding information at a time point at which a predetermined time elapses from the completion of the boarding mode in step S550. In addition, when the boarding information is transmitted to the external terminal according to the second notification condition, the control unit 118 acquires only changed boarding information at a predetermined time interval and continuously transmits the boarding information to the external terminal.

Further, when the determined notification condition is a third notification condition in step S560. the control unit 118 continuously tracks information on a current location of the vehicle, and thus the control unit 118 determines whether the current location of the vehicle departs to a route other than the traveling route between the departure and the destination, the boarding information is transmitted at a time point at which the current location of the vehicle departs the traveling route in step S570.

Furthermore, when the determined notification condition is a fourth notification condition in step S580, the control unit 118 transmits the boarding information to the external terminal when a boarding termination event does not occur even after the required travel time elapses on the basis of the time required to travel to a previously expected destination in step S570.

At this point, a plurality of notification conditions for transmitting the above-described boarding information may be set at the same time, and thus, the control unit 118 may transmit the boarding information according to an event corresponding to one of the predetermined plurality of notification conditions.

In other words, when all of the first to fourth notification conditions are selected, the control unit 118 transmits the boarding information to the external terminal at a time at which the first notification condition occurs, a time at which the second notification condition occurs, a time at which the third notification condition occurs, and a time at which the fourth notification condition occurs.

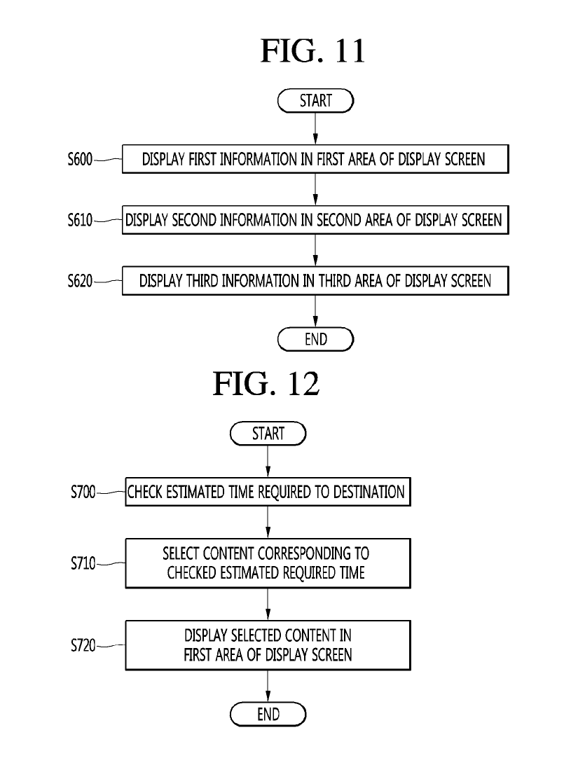

FIG. 11 is a flowchart sequentially illustrating an operating method of a display device in the traveling mode according to an embodiment of the present invention, and FIGS. 12 to 14 are flowcharts for explaining a content selection method according to an embodiment of the present invention,

Referring to FIG. 11, when the control unit 118 enters the traveling mode, the control unit 118 displays first information in a first area of the display unit 1171 in step S600. Here, vehicle information and driver information are displayed in the first area before the vehicle enters the traveling mode, and thus the information displayed in the first area is changed to the first information as the vehicle enters the traveling mode. The first information will be described in detail below.

Then, the control unit 118 displays second information in a second area of the display unit 1171 in step S610. The second information may be news information, and the control unit 118 receives real-time news information from the server 300 to display the received news information in the second area.

In addition, the control unit 118 displays third information in a third area of the display unit 1171 in step S620. Here, the third information may be additional information.

The additional information may include weather information and date information, and may include travel distance information and fare information related to traveling.

Referring to FIG. 12, when a destination is set, the control unit 118 calculates a traveling time required from a current location to the destination in step S700.

When the required traveling time is calculated, the control unit 118 selects content stored in the memory 115 or content having a playback length corresponding to the required traveling time among content existing in the server 300 as the first information in step S710. Here, the selection of the first information may performed by displaying a list of content having a playback length corresponding to the required traveling time, and receiving a selection signal of a specific piece of content on the displayed list from the passenger.

Then, when the first information is selected, the control unit 118 displays the selected first information in the first area of the display unit 1171 in step S720.

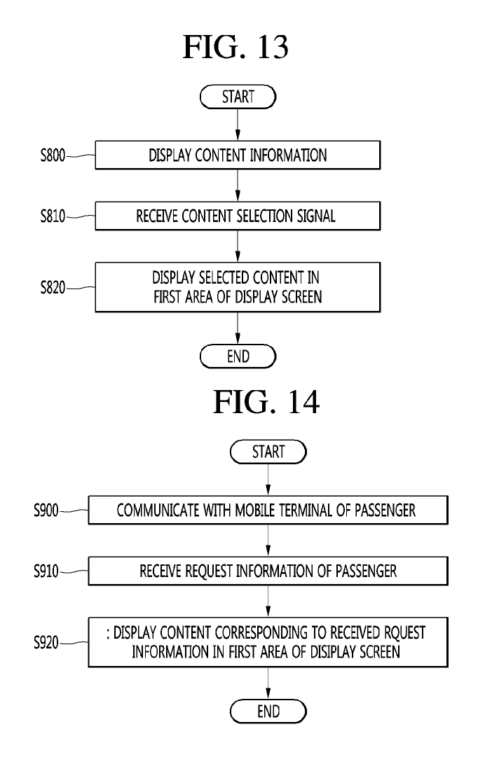

Referring to FIG. 13, the control unit 118 displays a list of pre-stored content and content provided by the server in step S800.

Then, the control unit 118 receives a selection signal of a specific piece of content on the displayed content list in step S810.

In addition, when the selection signal is received, the control unit 118 sets the selected content as the first information, and thus the control unit 118 displays the set first information in the first area of the display unit 1171 in step S820.

Referring to FIG. 14, the control unit 118 communicates with the passenger's terminal 200 in step S900.

In addition, the control unit 118 receives request information of the passenger from the terminal 200 in step S910.

Here, the request information may be information about a piece of content or an application that is currently being executed through the terminal 200.

In addition, when the request information is received, the control unit 118 checks for content corresponding to the received request information, and thus the control unit 118 sets the checked content as the first information and displays the first information in the first area of the display unit 1171 in step S920.

Meanwhile, when content is continuously played through the display unit 1171, a passenger may be able to watch the content playback with interest or not enjoy the playback of the content. Accordingly, the control unit 118 detects a state of the boarded passenger, and thus the control unit 118 changes a display condition of the display unit 1171 according to the detected state.

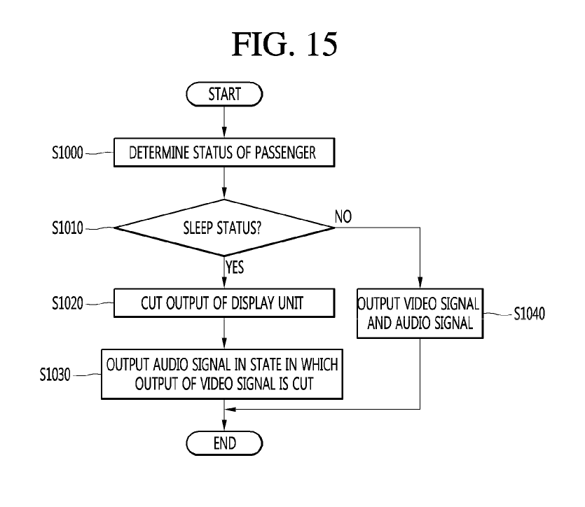

FIG. 15 is a flowchart sequentially illustrating a method of controlling a display screen in the traveling mode according to an embodiment of the present invention.

Referring to FIG. 15, the control unit 118 determines a state of a passenger on the basis of a detected image through the status sensing unit 113 in step S1000.

Then, the control unit 118 determines whether the determined passenger state is a sleep state in step S1010.

In addition, when the passenger is in the sleep state, the control unit 118 cuts off an output of the display unit 1171 in step S1020. In other words, the control unit 118 transmits only an audio signal among a video signal and the audio signal to be output to the audio output module, and does not transmit the video signal. Alternatively, the control unit 118 cuts off power supplied to the display unit 1171.

Then, the control unit 118 outputs only the audio signal when the output of the video signal is cut off by the cut-off output of the display unit 1171 in step S1030.

Further, the control unit 118 may not cut off the output of the video signal and may change a brightness level of the display unit 1171 to be the lowest level.

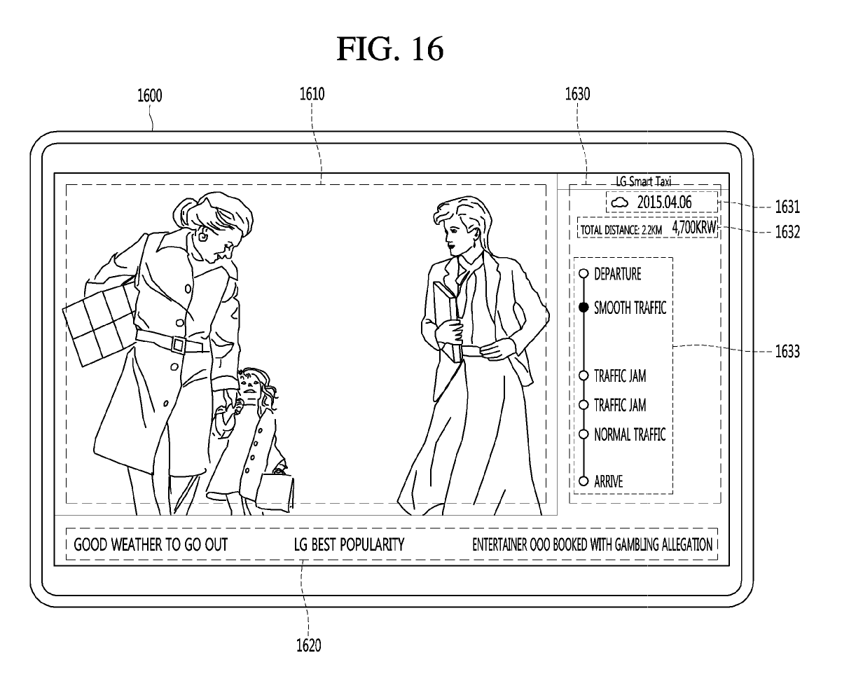

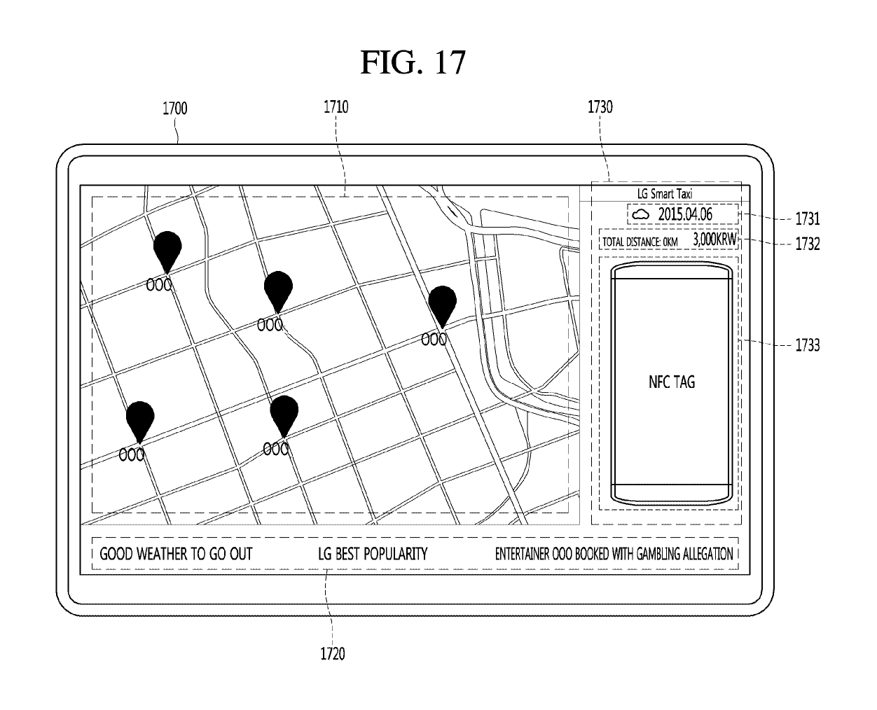

FIGS. 16 and 17 illustrate information displayed through the display unit 1171.

Referring to FIG. 16, a display screen 1600 is divided into a first area 1610, a second area 1620, and a third area 1630.

In addition, the above-described first information is displayed in the first area 1610. At this point, when no selection process of the first information is performed, the control unit 118 may set content, such as advertisement information, set as default information as the first information, and thus the control unit 118 may display the set first information in the first area 1610.

Further, real-time news information received from the server 300 is displayed in the second area 1620.

Furthermore, additional information is displayed in the third area 1630, the additional information includes a first additional information display area 1631 displaying weather and date information, a second additional information display area 1632 displaying a travel distance and fare information of a vehicle, and a third additional information display area 1633 displaying real-time traffic situation information on a traveling route of the vehicle.

Referring to FIG. 17, a display screen 1700 is divided into a first area 1710, a second area 1720, and a third area 1730.

In addition, the above-described first information is displayed in the first area 1710. At this point, when no selection process of the first information is selected, the control unit 118 may set content, such as advertisement information, set as default information as the first information, and thus the control unit 118 may display the set first information in the first area 1710.

At this point, the first information may be map information including location information on a set destination, and major building information, restaurant information, and the like around the destination may be displayed on the map information.

Further, real-time news information received from the server 300 is displayed in the second area 1720.

Furthermore, additional information is displayed in the third area 1730, the additional information includes a first additional information display area 1731 displaying weather and date information, a second additional information display area 1732 displaying a travel distance and fare information of a vehicle, and a third additional information display area 1733 displaying real-time traffic situation information on a traveling route of the vehicle. At this point, the control unit 118 may display information for inducing communication with a terminal in the third additional information display area 1733 before the vehicle enters the traveling mode.

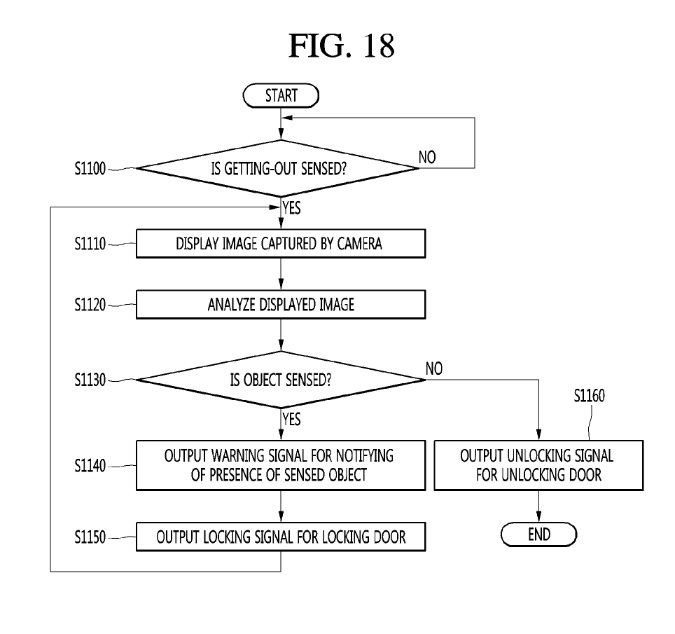

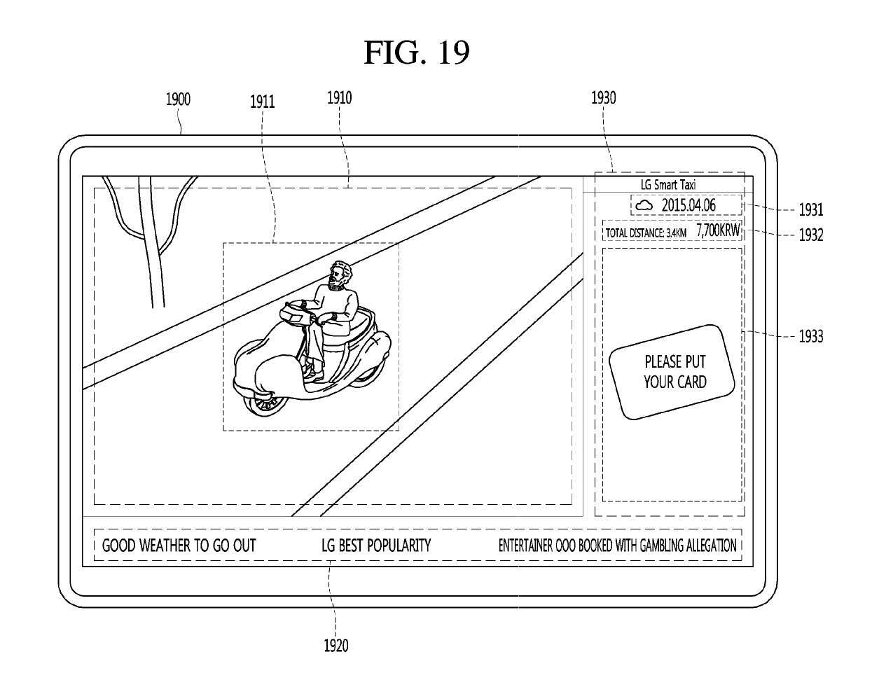

FIG. 18 is a flowchart illustrating an operating method of a display device in a getting-out mode according to an embodiment of the present invention, and FIG. 19 illustrates a display screen in the getting-out mode according to an embodiment of the present invention.

Referring to FIG. 18, the control unit 118 determines whether a getting-out of a passenger is detected in step S1100.

That is, the control unit 118 compares the current location of a vehicle with predetermined destination information, and thus the control unit 118 may detect whether the passenger is getting out of the vehicle or not. For example, the control unit 118 may enter the getting-out mode when the vehicle arrives near the destination.

In addition, when the control unit 118 detects the getting-out, the control unit 118 displays an image captured by the camera 120 via the display unit 1171 in step S1110.

The camera 120 is installed outside the vehicle and may acquire an image in at least one of frontward, rearward, and sideward direction of the vehicle to transmit the acquired image to the display device. Here, the camera 120 is preferably a rear camera.

At this point, the control unit 118 may perform the getting-out detection by a method other than comparing the destination and the current location. For example, the control unit 118 may detect a time point at which an event for fare payment occurs as the passenger arrives at the destination as the getting-out time point. The fare payment event may be generated by pressing a fare payment button of a meter to confirm a final fare.

Meanwhile, the control unit 118 may display fare information generated together with the image in addition to the image acquired through the camera 120 via the display unit 1171.

At this point, the control unit 118 may enlarge the image and fare information and may display the image and fare information on the display screen, and thus the passenger can more easily identify the image and fare information.

Referring to FIG. 19, an image 1900 displayed through the display unit 1171 in the getting-out mode is divided into a first area 1910 displaying a captured external image acquired through the camera 120, a second area 1920 displaying additional information such as news information, and a third area 1930 displaying additional information related to travel.

The image captured by the camera 120 is displayed in the first area 1910.

At this point, when the camera 120 is formed with a plurality of cameras, the first area 1910 may be divided into a plurality of areas corresponding to the number of cameras 120, and thus the image acquired through the camera 120 may be displayed in the plurality of areas.

The third area 1930 includes a first additional information display area 1931 displaying weather and date information, a second additional information display area 1932 displaying total distance traveled by the vehicle information and fare information, and a third additional information display area 1933 displaying information for confirming the fare information and inducing fare payment,

The passenger may easily identify an external situation on the basis of an image displayed in the first area 1910 of the display screen at a time of getting out of the vehicle, and thus the passenger can safely get out of the vehicle.

Referring back to FIG. 18, the control unit 118 analyzes an image displayed through the first area of the display screen in step S1120. That is, the control unit 118 compares a previously stored reference image with the displayed image, and checks whether there is a traveling object in the displayed image.

In addition, the control unit 118 determines whether an object such as a human body or an object exists is in the image according to an analysis result of the displayed image in step S1130.

Referring to FIG. 19, the first area includes an object 1911 that may give a risk of a getting-out passenger. The control unit 118 analyzes the image and determines whether the object 1911 exists in the image.

In addition, when an object exists in the image, the control unit 118 outputs a warning signal indicating the presence of the detected object in step S1140.

Then, the control unit 118 outputs a lock signal for locking a vehicle door in step S1150. That is, the control unit 118 outputs the locking signal for preventing the door from being opened to prevent the door of the vehicle from being opened due to the passenger not recognizing the object.

In addition, when an object does not exist in the image, the control unit 118 outputs a lock release signal for unlocking the door, and thus the passenger can get out of the vehicle in step S1160.

According to an embodiment of the present invention, when a passenger boards a vehicle, information on the vehicle boarded by the passenger and information of a driver are displayed, and when a destination for a traveling place of the vehicle is set, boarding information is transmitted to an acquaintance of the passenger, and thus the safety of the passenger can be ensured.

In addition, according to an embodiment of the present invention, various additional pieces of information such as commercial broadcasting, information on surroundings of a destination, news information, real-time traffic situation information, route information, and real-time fare payment information are provided while the vehicle is traveling, thereby eliminating boredom of the passenger while the vehicle is traveling to the destination and improving user satisfaction.

Further, according to an embodiment of the present invention, when a passenger gets out of a vehicle, an image of surroundings of the vehicle acquired through a camera is displayed, and when a moving object such as a motorcycle exists in the surroundings of the vehicle, a warning signal is output or a vehicle door is locked such that the vehicle door cannot be opened, thereby safely protecting the passenger at a time at which the passenger gets out of the vehicle.

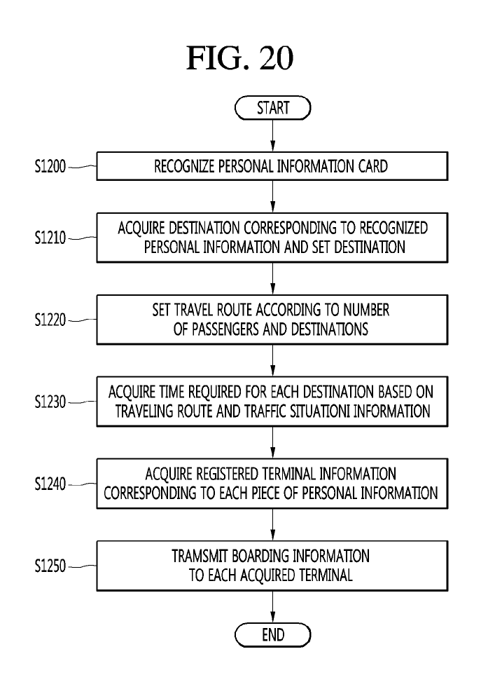

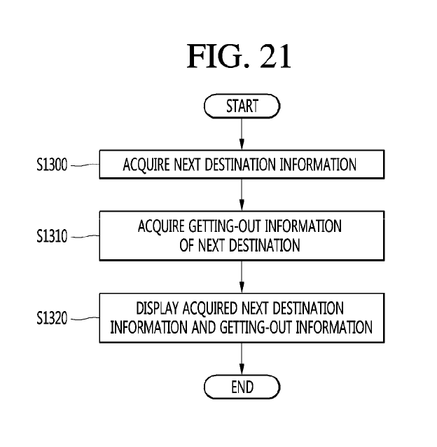

FIGS. 20 and 21 are flowcharts for sequentially describing an operating method of a display device according to another embodiment of the present invention.

That is, the previously described operating method of the display device is a case in which the display device is mounted on a vehicle such as a taxi, and FIGS. 20 and 21 are cases in which the display device is mounted on a vehicle such as a school bus.

Referring to FIG. 20, as a user first gets on a vehicle (here, a passenger may be a student who is going to school or going home from school), the control unit 118 recognizes a personal information card owned by the user in step S1200.

That is, according to an embodiment, in order to manage users, when registration such as a register certificate is made, a personal information card is issued to the registered users. The personal information card stores departure and destination information of the user and further stores contact information. A contact may be a contact of the user him or herself, and may preferably be a contact of a guardian such as the user's parents.

When the personal information card is recognized, the control unit 118 acquires the destination information of the user from the recognized personal information and sets a destination of the vehicle using the acquired destination information in step S1210.

Here, when there are a plurality of recognized personal information cards, the control unit 118 acquires a plurality of pieces of destination information to set an optimal destination route for each of the plurality of destinations according to the acquired destination information in step S1220. Since this is a general navigation technique, a detailed description thereof will be omitted.

Then, the control unit 118 acquires information of a time required to travel to each of the destinations on the basis of the set traveling route and traffic situation information in step S1230.

For example, when users aboard the vehicle are a first user, a second user, and a third user, the first user travels to a first destination, the second user travels to a second destination, the third user travels to a third destination, and the set traveling route is sequentially set from a current location to the first destination, the second destination, and the third destination, the control unit 118 predicts a first time required to travel from the current location to the first destination.

In addition, the control unit 118 predicts a second required time from the current location to the second destination through the first destination. Likewise, the control unit 118 predicts a third time required to travel from the current location to the third destination through the first destination and the second destination.

Then, the control unit 118 acquires registered terminal information corresponding to each of the pieces of personal information in step S1240. That is, the control unit 118 acquires terminal information of the first user, terminal information of the second user, and terminal information of the third user in step S1240.

Further, when the terminal information is acquired, the control unit 118 transmits boarding information of each of the users to the acquired terminal in step S1250.

That is, the control unit 118 transmits a departure, the destination, the time required to travel to the destination (the above-described first required time), vehicle information, driver information, and the like to a terminal of the first user. Similarly, the control unit 118 transmits the boarding information to terminals of the second and third user.

Referring to FIG. 21, the control unit 118 acquires information on a next destination to which a vehicle is to travel in the traveling mode in step S1300.

When the next destination information is acquired, the control unit 118 acquires getting-out information for a user getting out of the vehicle at the next destination on the basis of the acquired next destination information in step S1310.

Then, the control unit 118 displays the acquired next destination information and the getting-out information through the display unit 1171 in step S1320.

Meanwhile, according to the present invention, the image acquired through the camera 120 is displayed at a time at which a specific getting-out event occurs. However, the user input unit 116 includes an input unit such as a rear camera switch key, and thus an image acquired through the camera 120 may be displayed on the display screen at a passenger desired time.

According to an embodiment of the present invention, when a passenger boards a vehicle, information on the vehicle boarded by the passenger and information of a driver are displayed, and when a destination for a traveling place of the vehicle is set, boarding information is transmitted to an acquaintance of the passenger, and thus the safety of the passenger can be ensured.

In addition, according to an embodiment of the present invention, various pieces of additional information such as commercial broadcasting, information surrounding a destination, news information, real-time traffic situation information, route information, and real-time fare payment information are provided while the vehicle is traveling, thereby eliminating boredom of the passenger while the vehicle is traveling to the destination and improving user satisfaction.

Further, according to an embodiment of the present invention, when a passenger gets out of a vehicle, an image of surroundings of the vehicle acquired through a camera is displayed, and when a traveling object such as a motorcycle exists in the surroundings of the vehicle, a warning signal is output or a vehicle door is locked such that the vehicle door cannot be opened, thereby safely protecting the passenger at a time at which the passenger gets out of the vehicle.

The features, structures, effects and the like described in the above embodiments are included in at least one embodiment and are not necessarily limited to only one embodiment. Furthermore, the characteristics, structures, effects, and the like illustrated in each of the embodiments may be combined or modified even with respect to other embodiments by those of ordinary skill in the art to which the embodiments pertain. Thus, content related to such a combination and variation should be construed as being included in the scope of the present invention.

Although embodiments have been described with reference to a number of illustrative embodiments thereof, it should be understood that numerous other modifications and embodiments that fall within the spirit and scope of the principles of this disclosure can be devised by those skilled in the art. For example, elements of the exemplary embodiments described herein may be modified and realized. In addition, differences related to such a variation and application should be construed as being included in the scope of the present invention defined in the following claims.

1. A display device mounted inside a vehicle, comprising:
a first communication unit connected to a camera and receive an image of an outside of the vehicle captured by the camera;
a second communication unit configured to perform communication with a first terminal of a passenger when the passenger is detected aboard the vehicle and to receive destination information of the passenger transmitted from the first terminal;
a location information acquiring unit configured to acquire location information of the vehicle;
a control unit configured to determine the destination of the vehicle using the destination information received through the second communication unit and control a display time point of the image received through the first communication unit on the basis of the destination of the vehicle and the acquired location information; and
a display unit configured to display the image captured by the camera according to a control signal of the control unit.

2. The display device of claim 1, wherein the display time point includes a time point at which the vehicle approaches within a predetermined distance radius of the destination.

3. The display device of claim 1, wherein the display time point is a getting-out time point of a passenger aboard the vehicle based on the destination.

4. The display device of claim 1, wherein the display time point includes a time point at which a fare payment event occurs.

5. The display device of claim 1, wherein the control unit controls the display unit to display travel-related information of the vehicle together with the captured image at the display time point, wherein the travel-related information includes at least one of travel distance information, traveling route information, and fare information.

6. The display device of claim 1, wherein the control unit analyzes the captured image, determines whether a predetermined object exists in the captured image, and controls the display device to output a warning signal according to whether an object exists in the captured image.

7. The display device of claim 6, wherein the control unit outputs a door lock signal for locking a door of the vehicle when the predetermined object exists in the captured image.

8. The display device of claim 1, wherein the control unit controls the display unit to display vehicle-related information when a passenger aboard the vehicle is detected, wherein the vehicle-related information includes vehicle information including at least one of a vehicle number and a vehicle type, and driver information including at least one of a driver name, a license registration number, and an affiliated company.

9. (canceled)

10. The display device of claim 1, wherein the control unit transmits boarding information of the passenger to an outside when the destination is set, and the boarding information includes at least one of a boarding time, boarding vehicle information, driver information, departure information, destination information, and information on a required time to the destination.

11. The display device of claim 10, wherein the control unit transmits the boarding information to at least one of the first terminal and a second terminal of another person registered in the first terminal, and the second communication unit acquires information of the second terminal through communication with the first terminal.

12. The display device of claim 11, wherein the control unit performs additional boarding information to be transmitted any one of the first and second terminals according to a predetermined notification condition, and the additional boarding information further includes real-time current location information according to movement of the vehicle.

13. The display device of claim 4, further comprising a third communication unit configured to acquire fare payment information from a fare payment device in accordance with an occurrence of the fare payment event.

14. The display device of claim 1, wherein the control unit controls a predetermined piece of content to be displayed through the display unit while the vehicle travels, and the piece of content includes at least one of an advertisement, news, a map around the destination, and traffic situation information on a route of the vehicle.

15. An operating method a display device, comprising:
communicating with a first terminal of a passenger and receiving destination information of the passenger when the passenger is detected aboard a vehicle;
acquiring current location information of the vehicle;
determining a getting-out time point of the passenger on the basis of the destination information and current location information; and
displaying a captured image of an outside of the vehicle at the getting-out time point.

16. The operating method of a display device of claim 15, wherein the determining of a getting-out time point comprises:
determining whether the vehicle enters a nearby area within a radius of a predetermined distance from the destination on the basis of the current location information; and
determining a time point at which the vehicle enters the nearby area as the getting-out time point.

17. The operating method of a display device of claim 15, further comprising determining whether a fare payment event occurs, wherein the captured outside image is displayed when the fare payment event occurs.

18. The operating method of a display device of claim 15, further comprising outputting a warning signal according to whether a predetermined object exists in the captured outside image.

19. (canceled)

20. The operating method of a display device of claim 15, further comprising transmitting boarding information of the vehicle to at least any one of the first terminal and a second terminal acquired from the first terminal at a predetermined information transmission time.
